(19) United States
(12) Patent Application Publication
(10) Pub. No.: US 2016/0321086 A1
(43) Pub. Date: Nov. 3, 2016

(54) RECORDING MEDIUM, INFORMATION PROCESSING TERMINAL AND CONTROL METHOD

(71) Applicant: FUJITSU LIMITED, Kawasaki-shi (JP)

(72) Inventor: Takeyuki Suzuki, Shizuoka (JP)

(73) Assignee: FUJITSU LIMITED, Kawasaki-shi (JP)

(21) Appl. No.: 15/062,494

(22) Filed: Mar. 7, 2016

(30) Foreign Application Priority Data
Apr. 28, 2015 (JP) 2015-091016

(51) Int. Cl. G06F 9/44; G06F 21/62

(52) U.S. Cl. CPC G06F 9/4421; G06F 21/629

(57) ABSTRACT

A processor of an information processing terminal performs communication with a server apparatus, stores an application program that is provided with operation condition information that defines an operation condition of an application program for a case in which the communication is restricted, obtains the operation condition information from the application program, and suppresses an operation of the application program according to the operation condition information, in response to a state in which the communication is restricted.

### CROSS-REFERENCE TO RELATED APPLICATIONS

This application is based upon and claims the benefit of priority of the prior Japanese Patent Application No. 2015-091016, filed on Apr. 28, 2015, the entire contents of which are incorporated herein by reference.

### FIELD

The embodiments discussed herein are related to a recording medium, an information processing terminal and a control method.

### BACKGROUND

In recent years, information processing terminals (hereinafter, referred to as “terminals”) such as smartphones, tablets and the like that are capable of performing mobile communications have become popular. Terminals are able to communicate with a server via a network to download application programs (hereinafter, referred to as “applications”) from the server and to upload data onto the server.

On such terminals, applications including business logics that are related to the details of the business have been operated. Applications that are allowed to be installed on a terminal may be defined for each user, in order to prevent information leakage, or in order to give operation permissions to operations for each user according to the authority given to the user, for example.

In addition, applications are changed in order to fix trouble in the application or according to a version upgrade. According to the change, operations are performed such as to notify the user of the change and to prompt an update, or to perform a forced update, and so on.

As examples of technologies related to terminals, there are the following technologies.

For example, a program execution technology for a thin client system that includes a mobile terminal that functions as a client terminal has been proposed (for example, Patent document 1).

Meanwhile, a technology has been proposed for performing various operation controls such as automatic booting, automatic stop, and log-on for a client apparatus, in a net boot system that boots up a client apparatus using a disk image in a storage apparatus on the network (for example, Patent document 2).

Meanwhile, a technology related to the management of the state of a terminal apparatus has been proposed (for example, Patent document 3).

Meanwhile, a technology related to the version management for programs and files in a terminal such as a mobile terminal that is available offline has been proposed (for example, Patent document 4).

[Patent document 1] Japanese Laid-open Patent Publication No. 2013-41351

[Patent document 2] Japanese Laid-open Patent Publication No. 2009-20748

[Patent document 3] Japanese Laid-open Patent Publication No. 2000-132436

[Patent document 4] Japanese Laid-open Patent Publication No. 2002-191039

### SUMMARY

According to an aspect of the embodiments, a non-transitory computer-readable recoding medium having stored therein a program that causes a processor of an information processing terminal communicates with a server apparatus to execute a process. The process includes obtaining, from an application program stored in the information processing terminal, operation condition information that defines an operation condition for the application program for a case in which the communication is restricted, and suppressing an operation of the application program according to the operation condition information, in response to a detection of a state in which the communication is restricted.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a block diagram of an information processing terminal;

FIG. 2 is a diagram for explaining an example of a process for suppressing the operation of a client APP according to the communication state of a terminal in the present embodiment;

FIG. 3 illustrates a functional block diagram of an information processing terminal in the present embodiment;

FIG. 4 illustrates a hardware configuration of a terminal in the present embodiment;

FIG. 5 illustrates an example of a user App list in the present embodiment;

FIG. 6 illustrates an example of user management information in the present embodiment;

FIG. 7 is a diagram for explaining procedures of uninstallation of a client App and deletion of user data in the present embodiment;

FIG. 8 illustrates the flow of a process for obtaining operation definition information in the present embodiment;

FIGS. 9A and 9B illustrate examples of operation definition information in the present embodiment (Example 1);

FIG. 10 illustrates the operation control flow for a client App in the offline state in the present embodiment (Example 1);

FIGS. 11A and 11B illustrate examples of operation definition information in the present embodiment (Example 2);

FIG. 12 illustrates the operation control flow for a client App in the offline state in the present embodiment (Example 2);

FIGS. 13A and 13B illustrate examples of operation definition information in the present embodiment (Example 3); and

FIG. 14 illustrates the operation control flow for a client App in the offline state in the present embodiment (Example 3).

### DESCRIPTION OF EMBODIMENTS

In a server apparatus (hereinafter, referred to as a “server”), applications are regularly updated. However, without connection to the server to synchronize applications, the terminal does not enter the state for taking in the applications updated on the server side.

For this reason, when a terminal is continuously used in an environment in which communication with the server is restricted, old applications continue to run on the terminal. As a result, for example, it is possible that the lack of consistency with the format of the latest application or the like will cause a problem in data quality or increase risks in terms of security.

In addition, the client resources are limited. For example, there is a capacity limit for the memory. For this reason, when data has stored in the memory to a certain extent at the client side, a request may be made to the user to upload the data onto the server.

However, when the access from the client to the server is restricted or when radio communication is restricted due to trouble occurring in the communication function of the client or the like, no communication is established with the server. As a result, there may be a case in which preservation of data exceeding the capacity limit is not guaranteed.

Thus, in the offline state, there is a risk of failure in keeping data maintainability at the terminal side.

In the embodiments below, the suppressing of the operation of an application according to the communication state of a radio communication is explained.

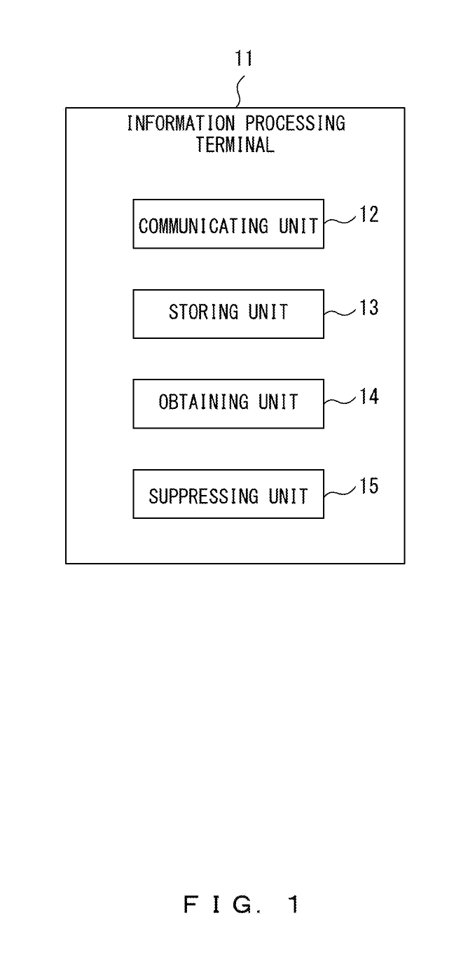

FIG. 1 illustrates an example of a block diagram of an information processing terminal in the present embodiment. First, as an example of the present embodiment, an information processing terminal 11 includes a communicating unit 12, a storing unit 13, an obtaining unit 14, and a suppressing unit 15.

The communicating unit 12 performs communication with the server apparatus. An example of the communicating unit 12 is a communication I/F 56, explained later.

The storing unit 13 stores an application program that is provided with operation condition information that defines operation conditions for the application program for the case in which the communication is restricted. An example of the storing unit 13 is a ROM 53 or a storing apparatus 57, explained later.

The obtaining unit 14 obtains operation condition information from the application program. An example of the obtaining unit 14 is a CPU 52, explained later.

The suppressing unit 15 suppresses the operation of the application program according to the operation condition information, in response to the detection of the state in which the communication is restricted. An example of the suppressing unit 15 is a CPU 52, explained later.

Therefore, data maintainability in an information processing terminal 11 in the offline state or at the time of transition from offline to online may be improved.

The operation condition information defines operation conditions for the case in which the communication function of the information processing terminal 11 is restricted. The suppressing unit 15 suppresses the operations of the application program according to the operation condition information, in response to the detection of the state in which the communication is restricted.

Therefore, in the case in which trouble occurs in the communication function of the information processing terminal 11, data maintainability in the information processing terminal in the offline state or at the time of transition from offline to online may be improved.

The operation condition information defines operation conditions for the case in which the communication between the terminal and the server is restricted. The suppressing unit 15 suppresses the operations of the application program according to the operation condition information, in response to the detection of the state in which the communication with the server is restricted.

Therefore, in the case in which trouble at the server side or trouble in the communication infrastructure between the server and the information processing terminal 11 occurs, data maintainability in the information processing terminal in the offline state or at the time of transition from offline to online may be improved.

When the time during which the communication is restricted exceeds a threshold set in the operation condition information, the suppressing unit 15 suppresses the operation of the application program that corresponds to the operation condition information.

Therefore, in the case in which the offline time exceeds the maximum disconnected time, the operation of the application may be suppressed, by forcibly terminating the application that is being executed, or by not launching the application for which an execution instruction has been issued, and so on.

In the case when the communication is restricted and the expiration deadline of the application program set in the operation condition has been exceeded, the suppressing unit suppresses the operations of the application program corresponding to the operation condition information.

Therefore, in the case in which the expiration deadline of the application is exceeded in the offline state, the operation of the application maybe suppressed, by forcibly terminating the application that is being executed, or by not launching the application for which an execution instruction has been issued, and so on.

In the case in which the communication is restricted and the used quantity of the storing apparatus of the information processing terminal 11 has exceeded a threshold set in the operation condition information, the suppressing unit 15 suppresses the operation of the application program corresponding to the operation condition information.

Therefore, in the case in which the memory usage has exceeded the maximum memory usage in the offline state, the operation of the application may be suppressed, by forcibly terminating the application that is being executed, or by not launching the application for which an execution instruction has been issued, and so on.

When the communication is restricted, the suppressing unit 15 suppresses the operation of the application program corresponding to the operation condition information by forcibly terminating the application that is being executed or by not launching the application program for which an execution instruction has been issued and making a prescribed message displayed.

Therefore, the operation of the application program may be suppressed.

Explained in the present embodiment is the suppressing of the operation of the application according to the condition for enabling execution (hereinafter, referred to as “runnable condition”) in the case in which the communication state of radio communication is offline, under the user environment of the logged-in user, in the information processing terminal 11 having a single-user environment or a multi-user environment. The runnable condition is a condition with respect to the period disconnected from the network, the expiration deadline of the application, or the memory usage, for example. Hereinafter, the application program is referred to as an “App”.

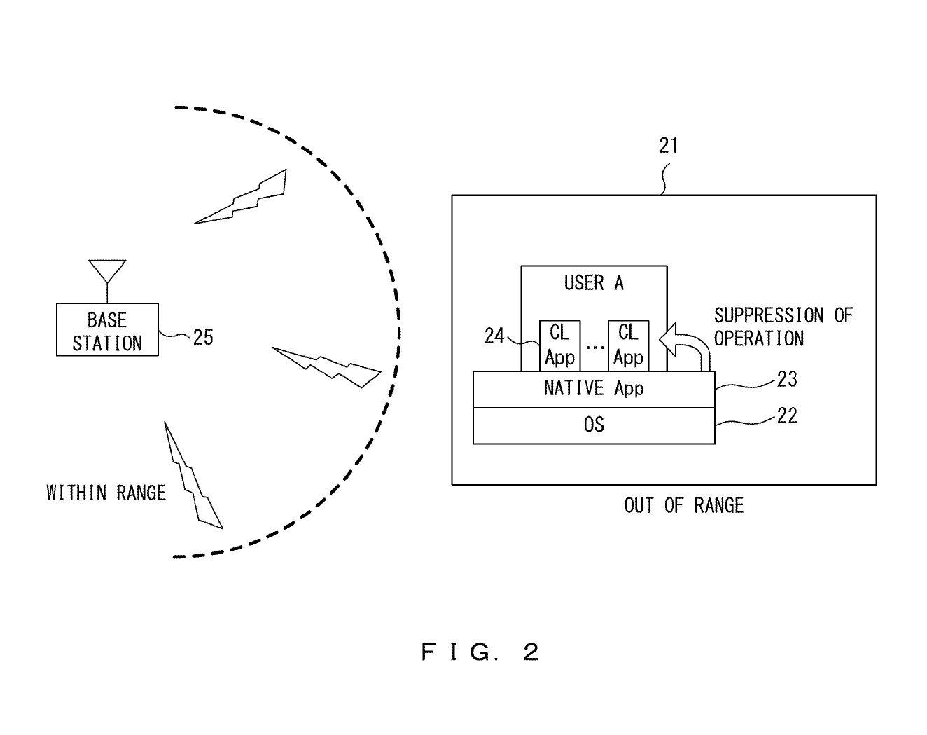

FIG. 2 is a diagram for explaining an example of a process for suppressing the operation of a client APP according to the communication state of a terminal in the present embodiment. A terminal 21 includes an operating system (OS) 22, a native App 23, and client Apps (CL App) 24. The client App is a generic term for Apps for the native App 23 and indicates the App among Apps that is controlled by the native App 23.

The OS 22 is basic software for making the terminal 21 operate. The OS 22 includes user environment information so that a single user or multiple users may log in. In addition, the OS 22 also manages application software (the client APP) 24 installed in the terminal 21 for each piece of user environment information.

The native App 23 is application software that launches on the OS 22, and it performs downloading of the client App from the server, installation and uninstallation of the client App into the terminal 21, referring to metadata of the client APP, and controlling (including suppressing) of operations of the client App.

The client App 24 is installed in the storing apparatus in the terminal 21, and it launches on the native App 23. The client App 24 performs input/output via the native App 23. In addition, the client App 24 is managed for each logged-in user.

When within the range of a base station 25, that is, when the communication state is good, each of the client Apps 24 installed in the terminal 21 operates according to the operation condition information corresponding to each of the client Apps 24. However, when out of the range of the base station 25, that is, when the communication state is bad, the native App 23 suppresses the operation of the client App 24 according to the operation condition information corresponding to the client App 24.

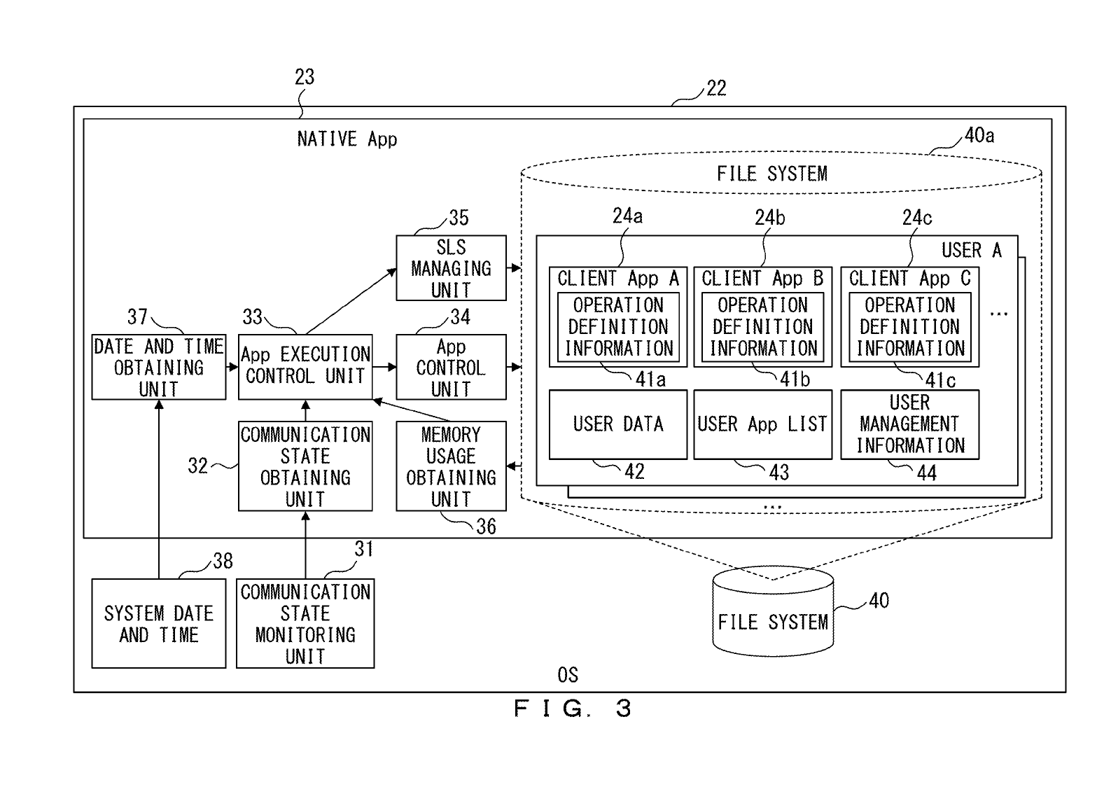

FIG. 3 illustrates a functional block diagram of the information processing terminal in the present embodiment. The OS 22 includes the communication state monitoring unit 31 and the file system 40. In addition, the OS 22 holds a system date and time 38.

The communication state monitoring unit 31 monitors information related to the communication state of the terminal 21, and reports the monitoring result to the communication state obtaining unit 32. Information related to the communication state of the terminal includes information that indicates that the communication is restricted in the case in which trouble occurs in the communication function of the terminal 21, and information that indicates that the communication is restricted in the case in which communication trouble occurs at the server side or trouble occurs in the communication infrastructure between the server and the terminal 11. Information related to the communication state of the terminal refers specifically to online/offline information for the communication network (3G/LTE (Long Term Evolution), Wi-Fi etc.) that is issued by the smart device. The file system is a mechanism for managing data stored in the storing apparatus.

The native App 23 is able to use a file system 40a that is assigned to the native App 23 among the file systems 40 of the OS 22. The file system 40a manages the client App 24 installed in the storing apparatus of the terminal 21, user data 42, a user App list 43, user management information 44 and so on, on a per-user basis for log-in.

The native App 23 keeps track of the operation state of Apps in operation by using the file system 40a. The user data 42 are data used by the installed client App 24 in the user environment of the logged-in user. The user data are managed by the file system 40a. In addition, the user data are stored in the secure local storage area (SLS) in which encrypted data are stored.

The user App list 43 is the list of installed Apps in the user environment of the logged-in user. The user management information 44 is information for managing, in the user environment of the logged-in user, the installed client Apps 24 and data (the user data) used by the client App 24.

The client Apps 24 (24a, 24b, 24c, . . . ) include operation definition information 41 (41a, 41b, 41c, . . . ), respectively.

The operation definition information 41 defines, for each client App 24, contents that are to be executed when the runnable condition is satisfied, and a forced uninstallation process specified as needed in the case in which the runnable condition is not satisfied, according to the communication state.

The runnable condition includes the maximum disconnected time that is the upper limit for the elapsed time since the client App 24 last terminated the connection with the server, the expiration deadline of the client App 24, the maximum memory usage for the client App 24, and the like, for example.

The native App 23 includes a communication state obtaining unit 32, an App execution control unit 33, an App managing unit 34, an SLS managing unit 35, a memory usage obtaining unit 36, and a date and time obtaining unit 37.

The communication state obtaining unit 32 obtains information related to the communication state of the terminal 21 reported from the communication state monitoring unit 31. Here, the communication state obtaining unit 32 measures the disconnected time (offline time) since the termination of the last network connection, according to the information related to the communication state.

The App execution control unit 33 controls execution and stopping of the client App 24. In addition, the App execution control unit 33 reads operation definition information 41 of the client App 24 via the App managing unit 34.

When the operation definition information 41 includes an instruction to uninstall the client App 24, the App execution control unit 33 instructs to the App managing unit 34 to uninstall the client App 24 under the prescribed condition.

Meanwhile, when an instruction to delete data related to the client App 24 is included, the App execution control unit 33 instructs to the App managing unit 34 to uninstall the client App 24 as well as to delete the user data related to the client App 24.

The App managing unit 34 performs downloading, installing, and uninstallation of the client App 24, and referring to meta data. For example, the App managing unit 34 performs uninstallation of the App 24 managed by the file system 40a, according to the instruction from the App execution control unit 33.

The SLS managing unit 35 writes the user data into the SLS, reads it from the SLS, or deletes the user data written into the SLS, via the file system 40a, according to the instruction from the App execution control unit 33.

The memory usage obtaining unit 36 obtains the usage of the memory (for example, a storing apparatus 57 explained later) from the file system 40.

The date and time obtaining unit 37 obtains the system date and time (38) from the OS 22.

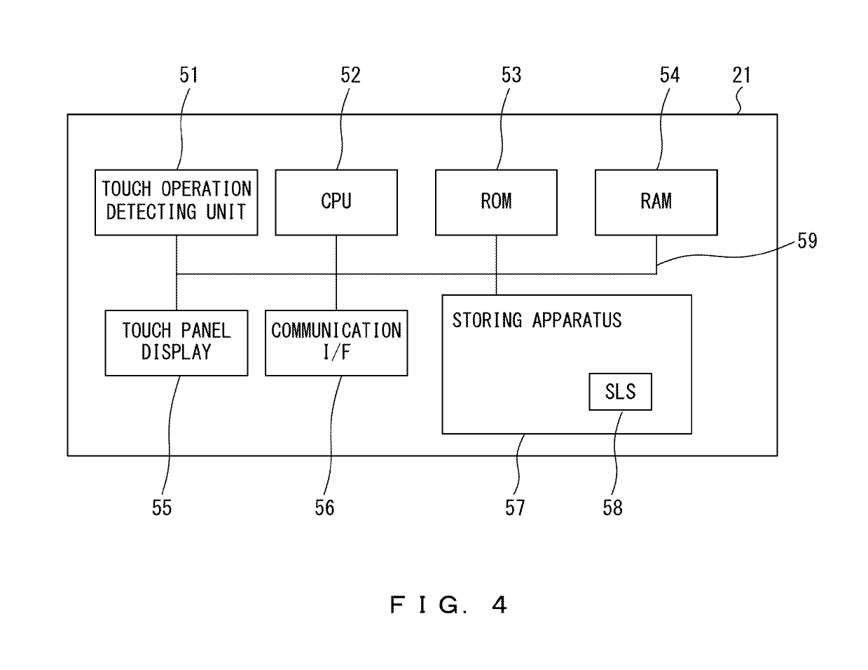

FIG. 4 illustrates the hardware configuration of the terminal in the present embodiment. The terminal 21 includes a touch operation detecting unit 51, a CPU 52, a ROM 53, a RAM 54, a touch panel display 55, a communication I/F 56, a storing apparatus 57, and a bus 59.

Here, the CPU is an example of a processor, and it refers to a central processing unit. The ROM refers to a read-only memory. The RAM refers to a random-access memory. The I/F refers to an interface. The touch operation detecting unit 51, the CPU 52, the ROM 53, the RAM 54, the touch panel display 55, the communication I/F 56, and the storing apparatus 57 are connected to the bus 59.

The touch panel display 55 is a display on which touch operations are available. The touch operation detecting unit 51 detects inputs into the touch panel display 55.

Storing apparatuses in various forms such as a hard disk, a semiconductor memory and the like may be used as the storing apparatus 57. The storing apparatus 57 includes a secure local storage area (SLS) 58 in which encrypted data are stored.

The storing apparatus 57 or the ROM 53 stores the program that executes processes according to the present embodiment and data and the like. As an example, the storing apparatus 57 stores the OS 22, the native App 23, the client App 24, and data and the like used by the client App 24.

The CPU 52 reads respective programs of the OS 22, the native App 23, the client App 24, and the like stored in the storing apparatus 57 or the like, and executes the respective programs.

The communication I/F 56 is a communication control circuit functioning as a communication interface corresponding to various communication standards such as 3G, LTE, Wi-Fi and the like. The communication I/F 56 is able to report the communication-available state in the case in which communication is available using the various communication standards. Meanwhile, the communication I/F 56 is able to report the communication-unavailable state in the case in which communication is unavailable using the various communication standards (for example, while being out of the communication area).

The program that realizes the processes explained in the embodiment above may be stored in the storing apparatus 57 from the program provider side via the communication network and the communication I/F 56. In addition, the program that realizes the processes explained in the present embodiment may be stored in a portable storage medium that is commercially sold and distributed. Storage media in various formats may be used as the portable storage medium, such as a CD-ROM, a flexible disk, an optical disk, a magneto-optical disk, an IC card, a USB memory device, and the like.

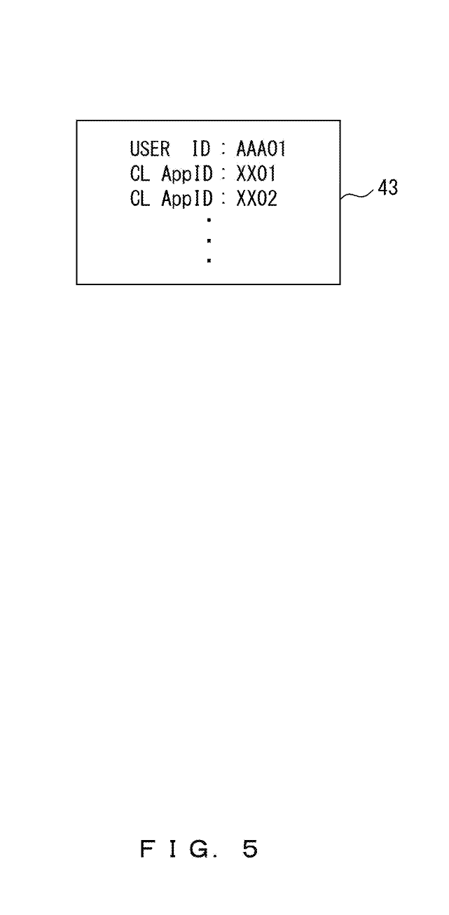

FIG. 5 illustrates an example of the user App list in the present embodiment. The user App list 43 is managed on a per-user basis and it is a list of the client Apps 24 installed in the terminal 21 under the log-in environment of the user. The user App list 43 includes “User ID” and “CL App ID”. The “User ID” is identification information that identifies the user who logs in. “CL App ID” is identification information assigned by the server that is the download source and that identifies the client App 24.

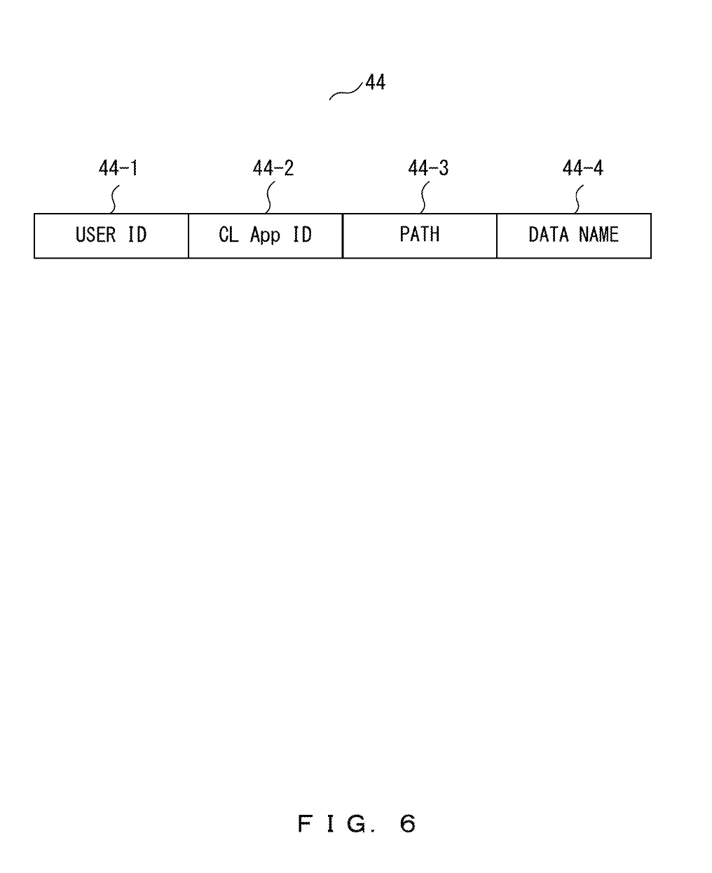

FIG. 6 illustrates an example of the user management information in the present embodiment. The user management information 44 is information for managing the installed client Apps 24 and data (the user data) used by the client Apps 24 in the user environment of the logged-in user.

The user management information 44 includes “User ID” 44-1, “CL App ID” 44-2, “path” 44-3, and “Data name” 44-4. The “User ID” 44-1 is identification information that identifies the user who logs in.

The “CL App ID” 44-2 is identification information 24 assigned by the server that is the download source and that identifies the client App. The “Path” 44-3 indicates the location of the user data used by the client App 24 in the file system 40a. The “Data name” 44-4 stores the data of the client Apps 24 (binary data) or the user data stored in the location specified by the “Path” 44-3.

The user management information 44 uses the CL App ID to take out the user data created by the target client App 24.

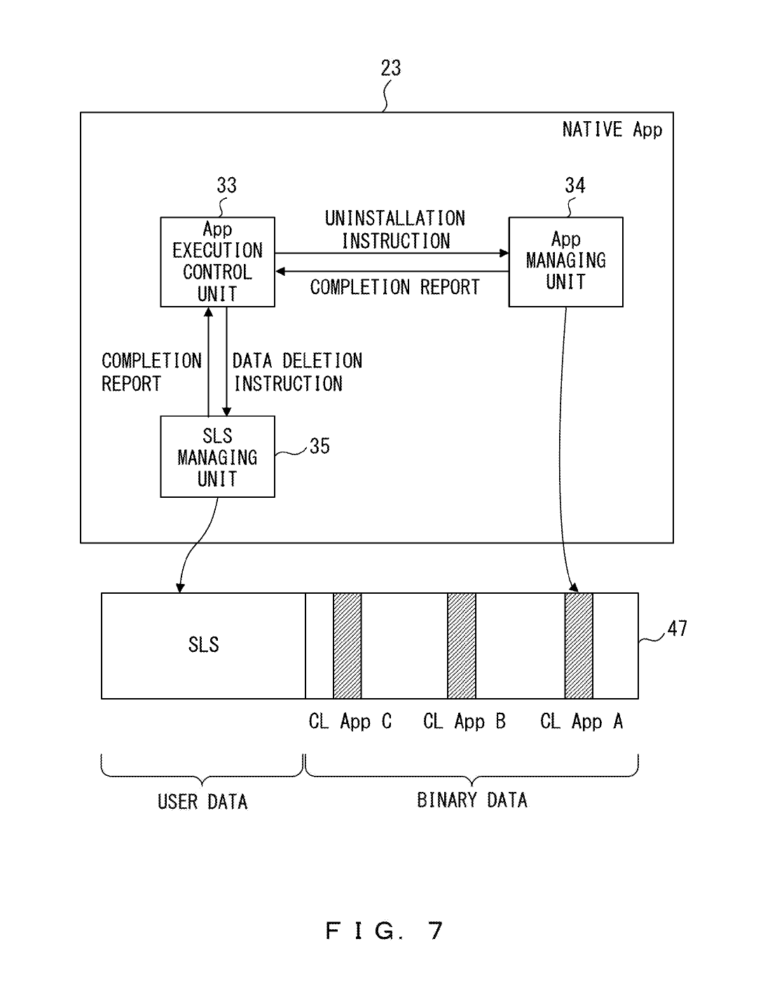

FIG. 7 is a diagram for explaining the procedure of uninstallation of the client App and deletion of the user data in the present embodiment. It is assumed that, in the case in which the App execution control unit 33 has received a report from the OS 22 indicating that communication is unavailable, the time disconnected from the network, the expiration deadline of the application, or the memory usage exceeds a prescribed value.

In the case in which the transition of the state of the time disconnected from the network, the expiration deadline of the application, or the memory usage in Examples 1-3 explained later does not correspond to the runnable condition defined in the operation definition information 41 and forced uninstallation is specified, the App execution control unit 33 performs the following process. That is, the App execution control unit 33 instructs to the App managing unit 34 to uninstall the client App 24 and instructs to the SLS managing unit 35 to delete the user data.

The App managing unit 34 performs uninstallation of the client App 24 (binary data) from the storing apparatus 57 according to the instruction from the App execution control unit 33. After the completion of the uninstallation, the App managing unit 34 reports the completion of the uninstallation of the client App 24 to the App execution control unit 33.

The SLS managing unit 35 performs the deletion of the user data from the SLS 48 according to the instruction from the App execution control unit 33. After the deletion of the user data, the SLS managing unit 35 reports the completion of the deletion of the user data to the App execution control unit 33.

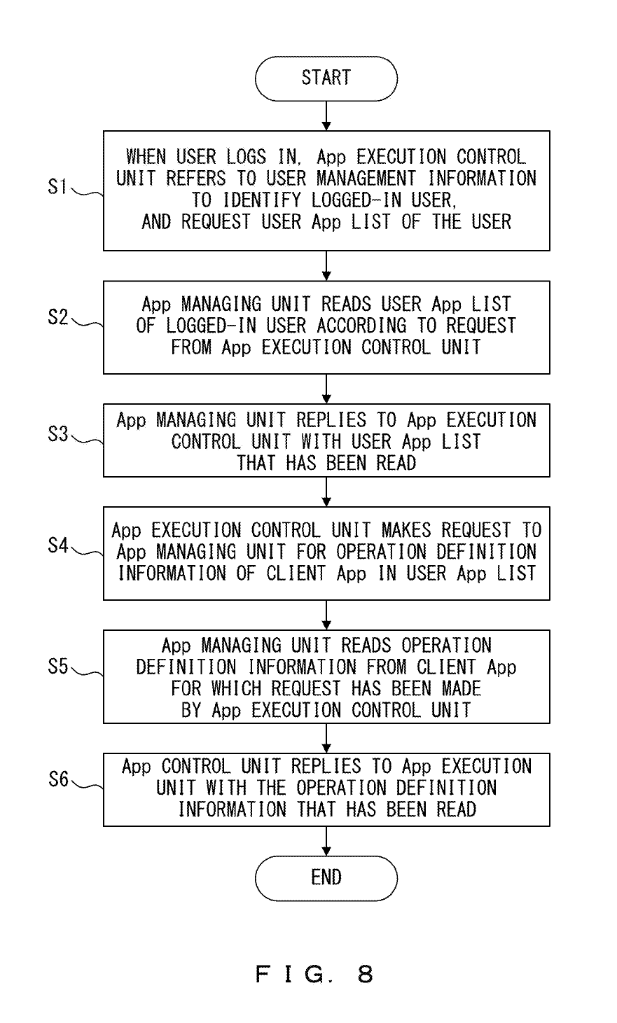

FIG. 8 illustrates the flow of the process for obtaining the operation definition information in the present embodiment. When the user logs in to the OS 22, the App execution control unit refers to the user management information 44 to identify the user who has logged in, and reports the user ID of the user to the App managing unit 34 and requests the user App list 43 for the user (S1).

The App managing unit 34 reads the user App list 43 of the logged-in user from the storing apparatus 57 using the user ID as the key, according to the request from the App execution control unit 33 (S2). The App managing unit 34 replies to the App execution control unit 33 with the user App list 43 that has been read (S3).

The App execution control unit 33 makes a request to the App managing unit 34 for the operation definition information of the respective client Apps 24 in the user app list 43 (S4).

The App managing unit 34 reads the operation definition information 41 from the respective client Apps 24 for which the request has been made by the App execution control unit 33 (S5).

The App managing unit 34 replies to the App execution control unit 33 with the operation definition information 41 that has been read (S6).

As an example of the present embodiment, hereinafter, Example 1 (control according to the time disconnected from the network), Example 2 (control according to the expiration deadline of the client App 24), and Example 3 (control according to the memory usage) are explained. However, these examples are just an example, and the values of the parameters used, the thresholds, the processing procedure, the data structure and the like are not limited.

Meanwhile, hereinafter, offline includes the case in which communication is restricted in a case in which trouble has occurred in the communication function of the terminal 21, and the case in which communication is restricted in a case in which communication trouble has occurred at the server side or trouble has occurred in the communication infrastructure between the server and the terminal 11.

### EXAMPLE 1

In Example 1, the suppressing of the operation of the client App 24 according to the time of the terminal 21 is disconnected from the network is explained.

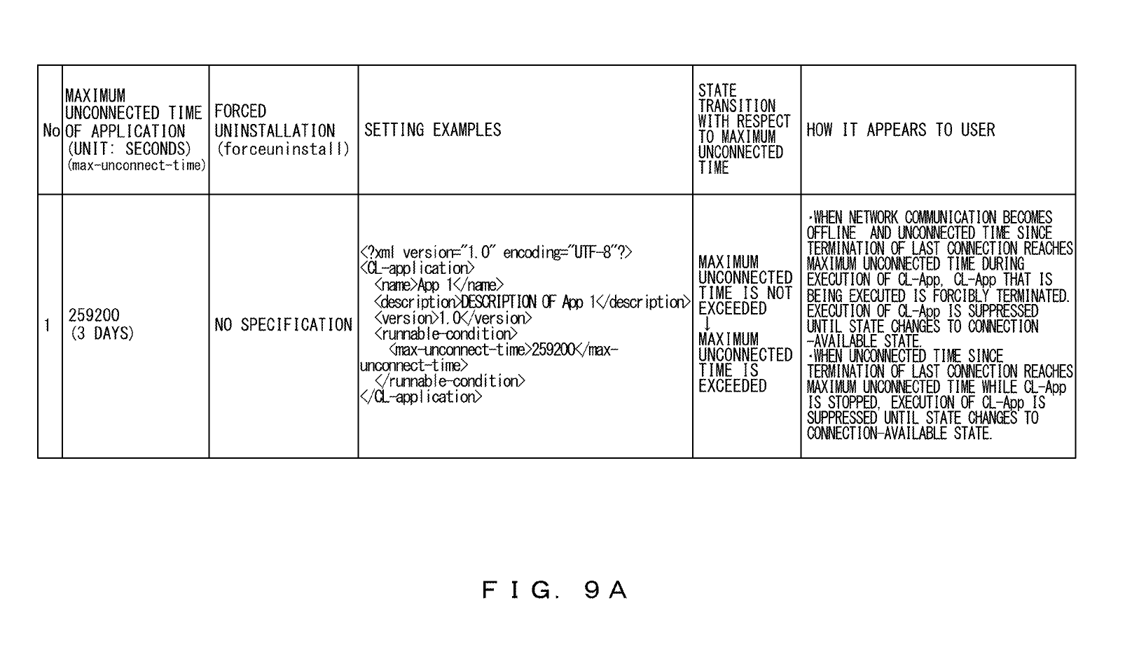

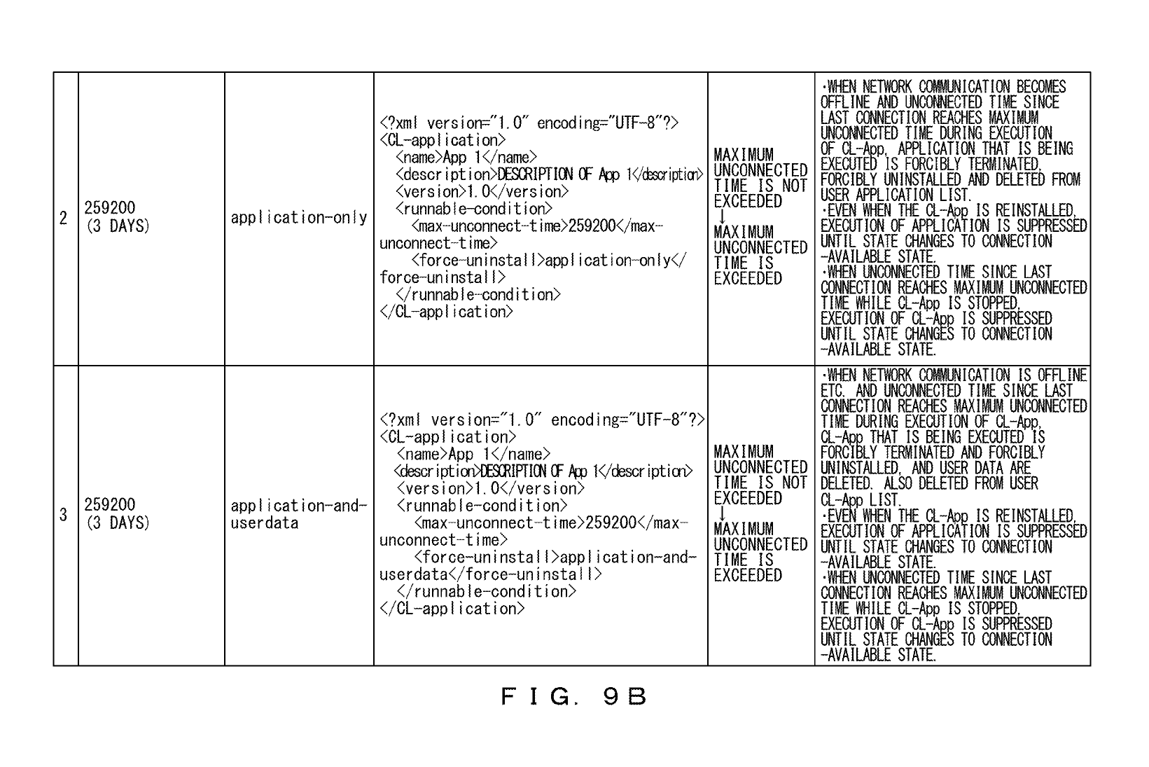

FIGS. 9A and 9B present examples of the operation definition information in the present embodiment (Example 1). In the present embodiment, each of the client Apps 24 has meta information in which operation is defined by XML (Extensible Markup Language), that is, the operation definition information 41. In the operation definition information 41 illustrated in FIGS. 9A and 9B, “CL-application” illustrates the route tag. The name of the client App 24 is set in “name”. The description of the client App 24 is set in “description”. The version of the client App 24 is set in “version”.

In “runnable-condition”, the definition of the operation conditions for the client App 24 is set as described below.

In “max-disconnect-time, the maximum disconnected time for the client App 24 is specified.

“force-uninstall” is specified in the case in which the client App 24 and the user data are to be forcibly uninstalled when the state of the client App 24 changes from the runnable state to the not-runnable state, that is, in the case of deviation from the runnable condition.

Values specified for “force-uninstall” are “application-only” and “application-and-userdata”. “application-only” is specified in the case in which the forced uninstallation is to be performed only for the client App 24. “application-and-userdata” is specified in the case in which the forced uninstallation is to be performed for the client App 24 and the user data.

FIGS. 9A and 9B describe setting examples of the “runnable-condition” for a certain client App. Hereinafter, each of the setting examples in FIGS. 9A and 9B is explained.

(Case No. 1)

The case in which the maximum disconnected time “259200” (seconds) (=3 days) of the client App 24 is specified in the runnable condition (max-disconnect-time) of the client App 24 and the forced uninstallation (force-uninstall) is not specified is explained.

When the elapsed time (seconds) (offline time) since the terminal 21 terminated communication with the server is smaller than the maximum disconnected time, the client App 24 operates in the range available in the offline state.

When the network enters the offline state and the disconnected time since the termination of the last network connection reaches the maximum disconnected time during the execution of the client App 24, the native App 23 performs forced termination of the client App 24 that is being executed. By the control by the native App 23, the execution of the client App 24 is suppressed until the state changes to the connection-available state (that is, the operation of the client App 24 is suppressed).

Meanwhile, when the disconnected time since the last connection reaches the maximum disconnected time while the client App 24 is stopped, the execution of the client App 24 is suppressed by the control by the native App 23 until the state changes to the connection-available state.

(Case No. 2)

The case in which the maximum disconnected time “259200” (seconds) (=3 days) of the client App 24 is specified in the runnable condition (max-disconnect-time) of the client App 24, and “application-only” is specified in “forced uninstallation (force-uninstall)” is explained.

When the elapsed time (seconds) (offline time) since the terminal 21 terminated communication with the server is smaller than the maximum disconnected time, the client App 24 operates in the range available in the offline state.

When the network enters the offline state and the disconnected time since the termination of the last network connection reaches the maximum disconnected time during the execution of the client App 24, the native App 23 performs forced termination of the client App 24 that is being executed. The native App 23 performs forced uninstallation of the client App 24 and deletes it from the user App list 43.

Even when the client App 24 is reinstalled, the execution of the client App 24 is suppressed by the control by the native App 23 until the state changes to the connection-available state.

When the disconnected time since the last connection reaches the maximum disconnected time while the client App 24 is stopped, the execution of the client App 24 is suppressed by the control by the native App 23 until the state changes to the connection-available state.

(Case No. 3)

The case in which the maximum disconnected time “259200” (seconds) (=3 days) of the client App 24 is specified in the runnable condition (max-disconnect-time) of the client App 24, and “application-and-userdata” is specified in “forced uninstallation (force-uninstall)” is explained.

When the elapsed time (seconds) (offline time) since the terminal 21 terminated communication with the server is smaller than 259200 seconds, the client App 24 operates in the range available in the offline state.

When the network enters the offline state and the disconnected time since the termination of the last network connection reaches the maximum disconnected time during the execution of the client App 24, the native App 23 performs forced termination of the application that is being executed. The native App 23 performs forced uninstallation of the client App 24, and deletes the user data. The native App 23 deletes the client App 24 from the user App list 43.

Even when the client App 24 is reinstalled, the client App 24 is not executed until the state changes to the connection-available state, by the control by the native App 23.

When the disconnected time since the last connection reaches the maximum disconnected time while the client App 24 is stopped, the execution of the client App 24 is suppressed by the control by the native App 23 until the state changes to the connection-available state.

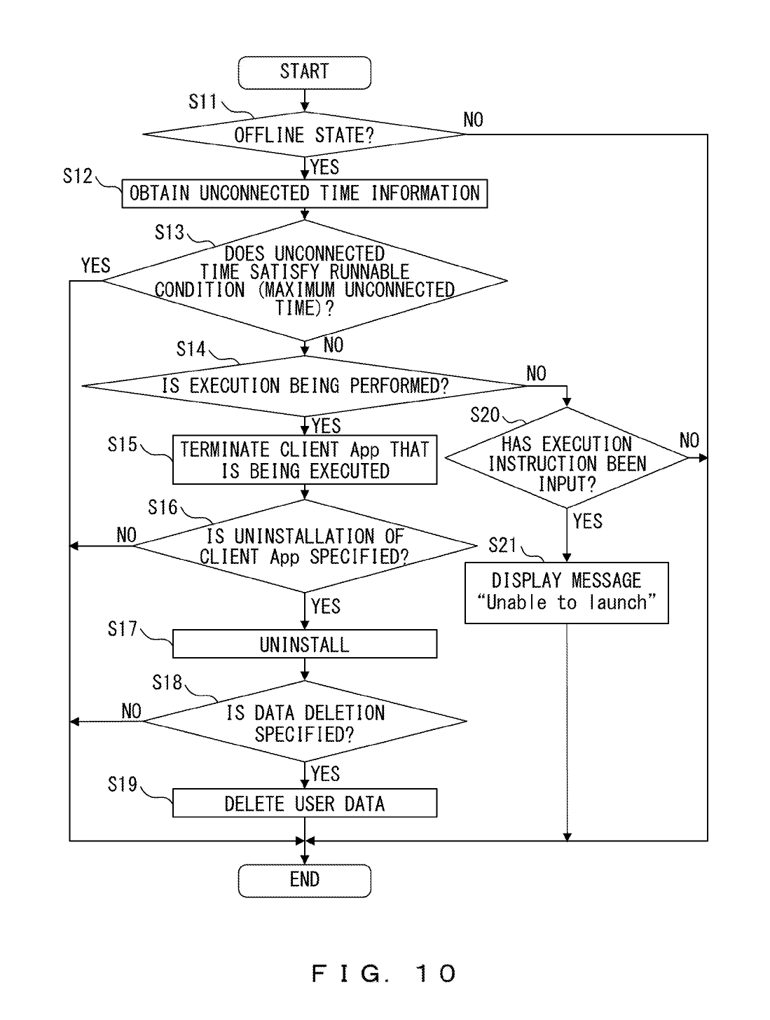

FIG. 10 illustrates the operation control flow for the client App in the offline state in the present embodiment (Example 1).

The communication state obtaining unit 32 obtains the communication state information of the terminal 21 from the communication state monitoring unit 31. The communication state obtaining unit 32 judges whether the terminal 21 is in the state in which it is not connected to the network (offline state) (S11). When the terminal 21 is in the state in which it is connected to the network (when it is in the online state), (S11, “NO”), this flow is terminated.

When the terminal 21 is in the state in which it is not connected to the network (when it is in the offline state) (S11, “YES”), the communication state obtaining unit 32 measures the time the terminal 21 is disconnected from the network, based on the obtained communication state information. The communication state obtaining unit 32 transmits the measured disconnected time to the App execution control unit 33. The App execution control unit 33 obtains the disconnected time from the communication state obtaining unit 32 (S12).

The App execution control unit 33 judges whether the obtained disconnected time corresponds to the runnable condition (the maximum disconnected time) defined in the operation definition information received from the App managing unit 34, as explained in FIG. 7 (S13). When the communication state corresponds to the runnable condition, that is, when the obtained disconnected time is equal to or smaller than the maximum disconnected time (S13, “YES”), this flow is terminated.

When the communication state does not correspond to the runnable condition, that is, when the disconnected time exceeds the maximum disconnected time (S13, “NO”), the App execution control unit 33 performs the following process.

That is, the App execution control unit 33 judges whether the client App 24 (the target client App) that does not correspond to the runnable condition is being executed on the native App 23 (S14). When the target client App is being executed (S14, “YES”), the App execution control unit 33 terminates the execution of the target client App (S15).

When the uninstallation of the target client App is not specified in the operation definition information 41 (S16, “NO”), this flow is terminated. When the uninstallation of the target client App is specified in the operation definition information 41 (S16, “YES”), the App execution control unit 33 instructs to the App managing unit 34 to uninstall the target client App. The App managing unit 34 performs uninstallation of the target client App according to the instruction (S17).

When there is no instruction to delete the user data of the target client App (the target user data) in the operation definition information 41 (S18, “NO”), this flow is terminated. When there is an instruction to delete the user data of the target client App (the target user data) in the operation definition information 41 (S18, “Yes”), the App execution control unit 33 instructs to the SLS managing unit 35 to delete the target user data. The SLS managing unit 35 deletes the target user data according to the instruction (S19).

When the target client App is not being executed (S14, “NO”), the App execution control unit 33 judges whether an instruction to execute the target client App has been input (S20).

An example of the input of the execution instruction is the touch operation made by the user on an icon of the client App 24 displayed on the touch panel display 55 with the intension of launching the client App 24. In addition, another example of the input of the instruction for execution is a launch instruction given with respect to the client App 24 from another program.

When no execution instruction for the target client App has been input (S20, “NO”), this flow is terminated. When an execution instruction for the target client App is input (S20, “YES”), the App execution control unit 33 causes a message “Unable to launch” to be displayed on the touch panel display 55 of the terminal 21 (S21).

According to Example 1, when the offline time exceeds the maximum disconnected time, the operation of the client App 24 may be suppressed by forcibly terminating the client App 24 that is being executed or by not launching the client App 24 for which an execution instruction has been issued, or the like.

### EXAMPLE 2

In Example 2, the suppressing of the operations of the client App 24 according to the expiration deadline of the client App 24 in the offline state of the terminal 21 is explained.

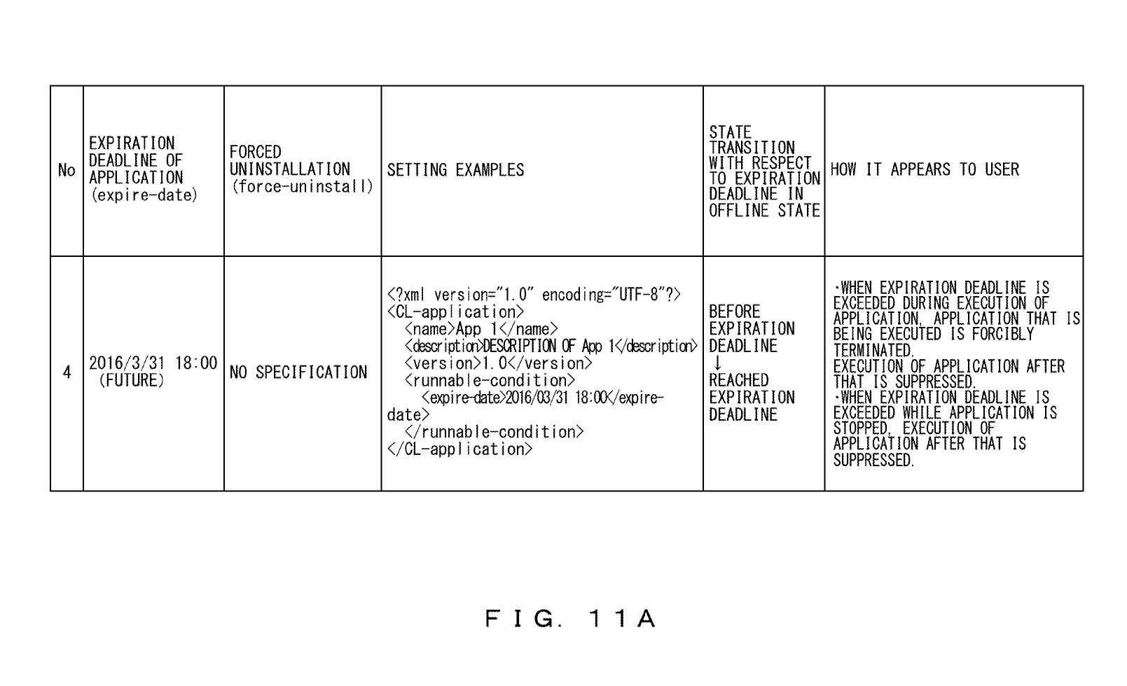

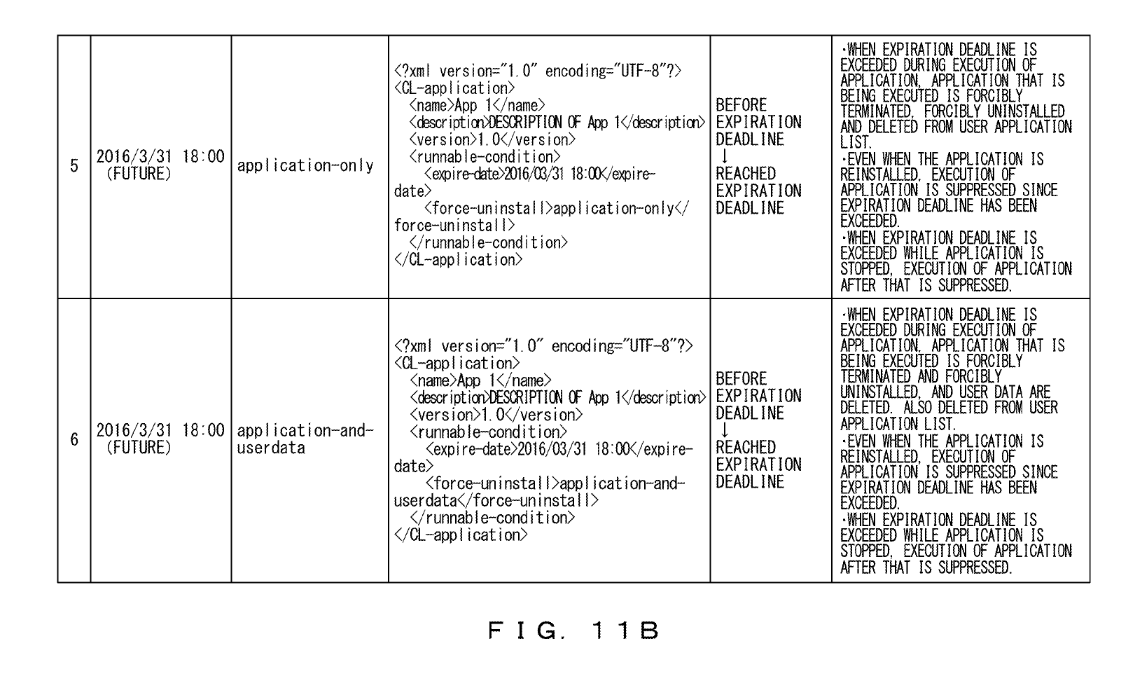

FIGS. 11A and 11B illustrate examples of the operation definition information in the present embodiment (Example 2). The operation definition information in FIGS. 11A and 11B is the information in which the expiration deadline (expire-date) of the application is set in a “runnable-condition” as the definition of the operation condition of the client App 24, and the other rules are the same as those in FIGS. 9A and 9B. Hereinafter, each of the setting examples in FIGS. 11A and 11B is explained.

(Case No. 4)

The case in which the expiration deadline “2016/3/31 18:00” (future date and time) of the client App 24 is specified in the runnable condition (expire-date) for example, and the forced uninstallation (force-uninstall) is not specified, is explained.

When the current date and time is the expiration deadline of the client App 24 or before, the client App 24 operates in the normal manner.

When the expiration deadline is exceeded during the execution of the client App 24 in the offline state, the native App 23 causes the client App 24 that is being executed forcibly to be terminated. After that, execution of the client App 24 is suppressed by the control by the native App 23.

In addition, when the expiration deadline is exceeded while the client App 24 is stopped in the offline state, the execution of the client App 24 after that is suppressed by the control by the native App 23.

(Case No. 5)

The case in which the expiration deadline “2016/3/31 18:00” (future date and time) of the client App 24 is specified in the runnable condition (expire-date) for example, and “application-only” is specified in the forced uninstallation (force-uninstall), is explained.

When the current date and time is the expiration deadline of the client App 24 or before in the offline state, the client App 24 operates in the normal manner.

When the expiration deadline is exceeded during the execution of the application in the offline state, the native App 23 causes the application that is being executed to be forcibly terminated. The native App 23 performs forced uninstallation of the client App 24, and deletes it from the user App list 43. Even when the client App 24 is reinstalled, the execution of the client App 24 is suppressed by the control by the native App 23, since the expiration deadline has been exceeded.

When the expiration deadline is exceeded while the client App 24 is stopped, the execution of the client App 24 after that is suppressed by the control by the native App 23.

(Case No. 6)

The case in which the expiration deadline “2016/3/31 18:00” (future date and time) of the client App 24 is specified in the runnable condition (expire-date) for example, and “application-and-userdata” is specified in the forced uninstallation (force-uninstall) is explained.

When the current date and time is the expiration deadline of the client App 24 or before, the client App 24 operates in the normal manner.

When the expiration deadline is exceeded during the execution of the application in the offline state, the native App 23 causes the application that is being executed to be forcibly terminated. The native App 23 performs forced uninstallation of the client App 24, and deletes the user data. The native App 23 deletes the client App 24 from the user App list 43.

Even when the client App 24 is reinstalled, the execution of the client App 24 is suppressed by the control by the native App 23, since the expiration deadline has been exceeded.

Meanwhile, when the expiration deadline is exceeded while the client App 24 is stopped in the offline state, the execution of the client App 24 after that is suppressed by the control by the native App 23.

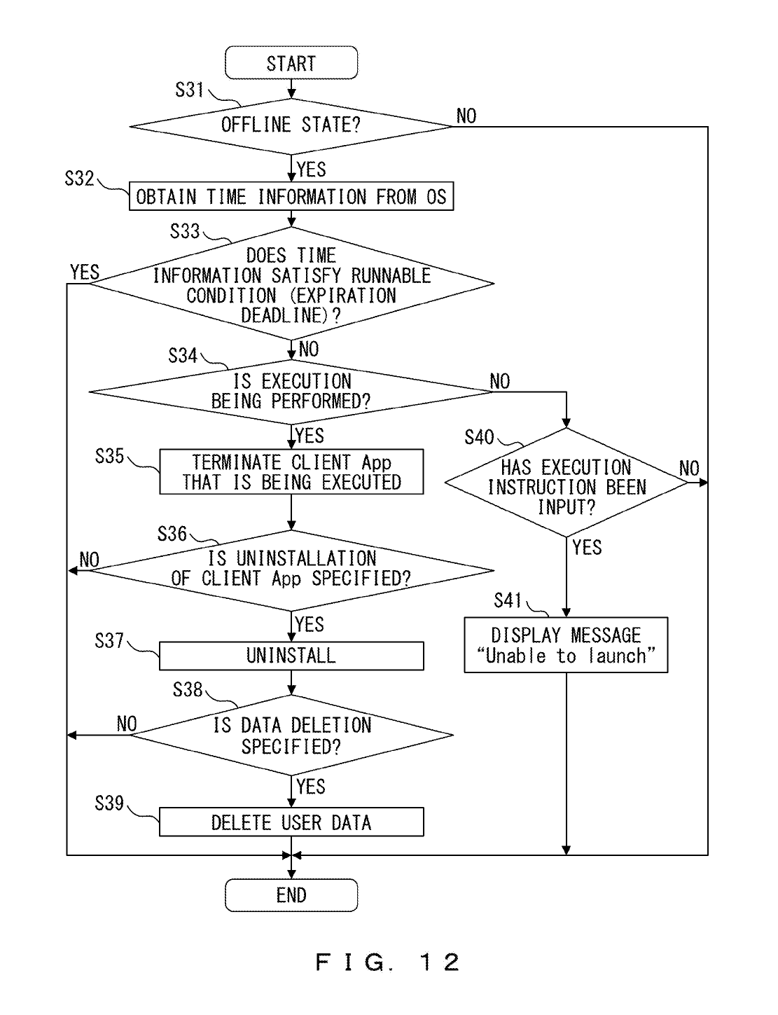

FIG. 12 illustrates the operation control flow for the client App in the offline state in the present embodiment (Example 2).

The communication state obtaining unit 32 obtains the communication state information of the terminal 21 from the communication state monitoring unit 31. The communication state obtaining unit 32 judges whether the terminal 21 is in the state in which it is not connected to the network (offline state) (S31). When the terminal 21 is in the state in which it is connected to the network (when it is in the online state) (S31, “NO”), this flow is terminated.

When the terminal 21 is in the state in which it is not connected to the network (when it is in the offline state) (S31, “YES”), the date and time obtaining unit 37 obtains the current system date and time (time information) from the OS (S32). The date and time obtaining unit 37 transmits the obtained time information to the App execution control unit 33. The App execution control unit 33 obtains the time information from the date and time obtaining unit 37.

The App execution control unit 33 judges whether the obtained time information corresponds to the runnable condition (the expiration deadline of the client App 24) defined in the operation definition information 41 received from the App managing unit 34, as explained in FIGS. 11A and 11B (S33). When the time information corresponds to the runnable condition, that is, when the current date and time is within the expiration time (S33, “YES”), this flow is terminated.

When the time information does not correspond to the runnable condition, that is, when the current date and time has exceeded the expiration time (S33, “NO”), the App execution control unit 33 judges whether the client App 24 (the target client App) that does not correspond to the runnable condition is being executed (S34). When the target client App is being executed on the native App 23 (S34, “YES”), the App execution control unit 33 terminates the execution of the target client App 24 (S35).

When the uninstallation of the target client App is not specified in the operation definition information 41 (S36, “NO”), this flow is terminated. When the uninstallation of the target client App is specified in the operation definition information 41 (S36, “YES”), the App execution control unit 33 instructs to the App managing unit 34 to uninstall the target client App. The App managing unit 34 performs uninstallation of the target client App according to the instruction (S37).

When there is no instruction to delete the user data of the target client App (the target user data) in the operation definition information 41 (S38, “NO”), this flow is terminated. When there is an instruction to delete the user data of the target client App (the target user data) in the operation definition information 41 (S38, “YES”), the App execution control unit 33 instructs to the SLS managing unit 35 to delete the target user data. The SLS managing unit 35 deletes the target user data according to the instruction (S39).

When the target client App is not being executed (S34, “NO”), the App execution control unit 33 judges whether an instruction to execute the target client App has been input (S40).

When no instruction to execute the target client App has been input (S40, “NO”), this flow is terminated. When an instruction to execute the target client App is input (S40, “YES”), the App execution control unit 33 causes a message “Unable to launch” to be displayed on the touch panel display 55 of the terminal 21 (S41).

According to Example 2, when the expiration deadline of the client App is exceeded in the offline state, the operation of the client App 24 may be suppressed by forcibly terminating the client App 24 that is being executed or by not launching the client App 24 for which an execution instruction has been issued.

### EXAMPLE 3

In Example 3, the suppressing of the operations of the client App according to the memory capacity of the terminal 21 in the offline state of the terminal 21 is explained.

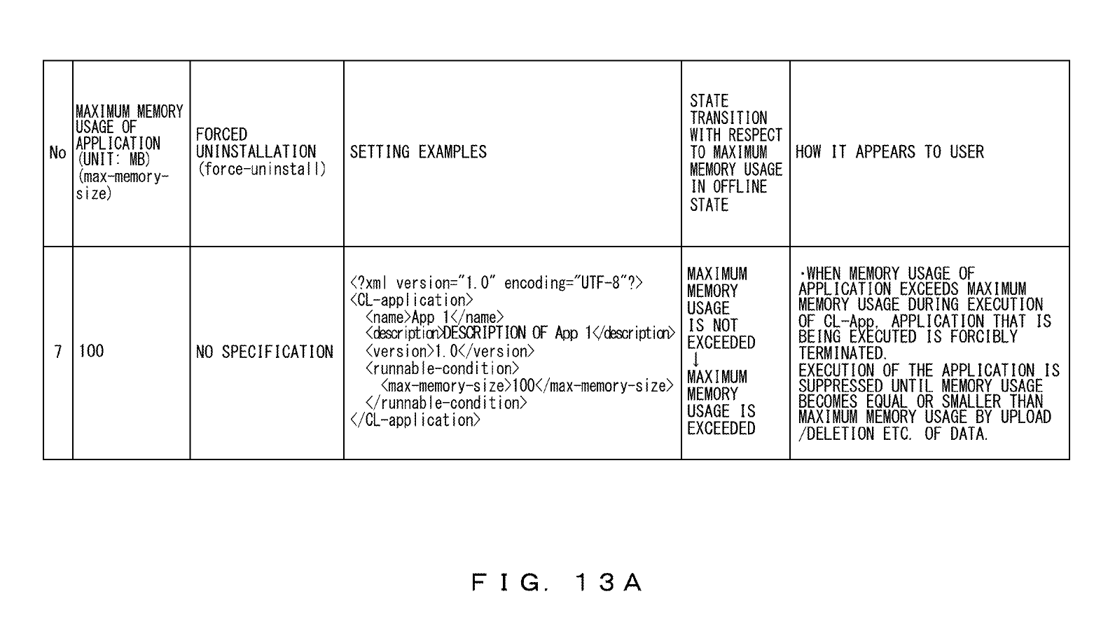

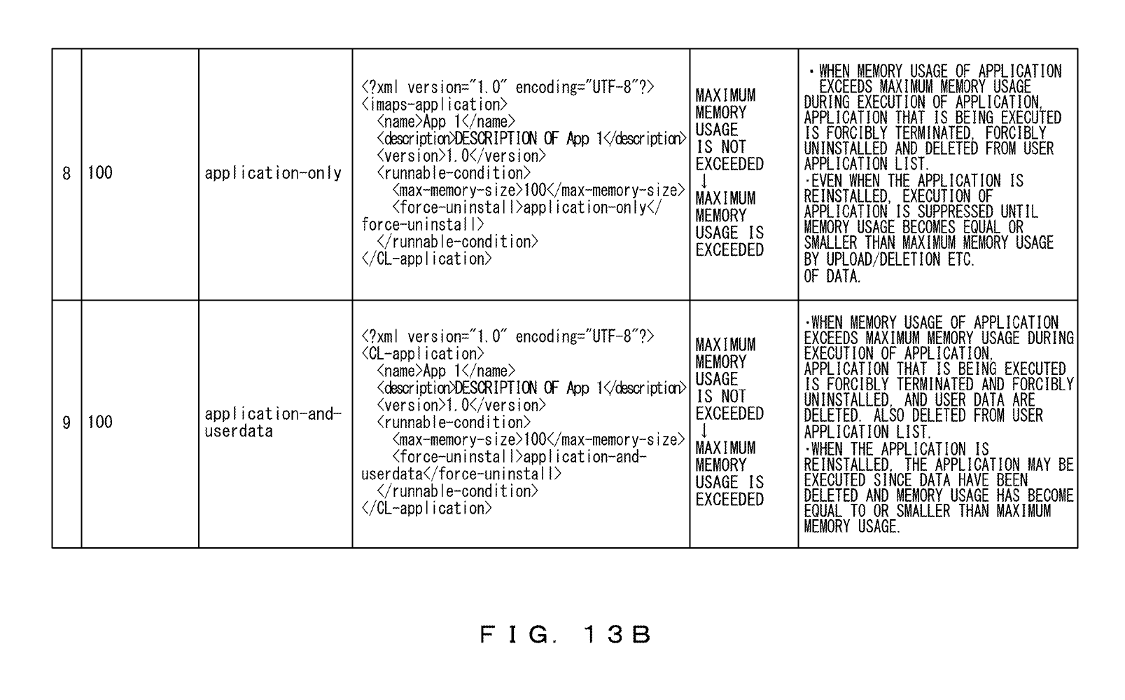

FIGS. 13A and 13B illustrate examples of the operation definition information in the present embodiment (Example 3). The operation definition information in FIGS. 13A and 13B is the information in which the maximum memory usage (unit: megabytes (MB)) of the client App is set in “runnable-condition” as the definition of the operation condition of the client App, and the other rules are the same as those in FIG. 7.

(Case No. 7)

The case in which the maximum memory usage “100” (unit: MB) of the client App is specified in the runnable condition (max-memory-size) of the client App for example, and the forced uninstallation (force-uninstall) is not specified, is explained.

When the current memory usage of the terminal 21 is equal to or smaller than the maximum usage of the client App, the client App operates in the normal manner.

When the memory usage exceeds the maximum memory usage during the execution of the client App in the offline state, the native App 23 causes the client App that is being executed to be forcibly terminated. The client App is not executed until the memory usage becomes equal to or smaller than the maximum memory usage by uploading data to the server or deleting data by the control of the native App 23.

(Case No. 8)

The case in which the maximum memory usage “100” (unit: MB) of the client App is specified in the runnable condition (max-memory-size) of the client App for example, and “application-only” is specified in the forced uninstallation (force-uninstall), is explained.

When the current memory usage of the terminal 21 is equal to or smaller than the maximum usage of the client App in the offline state, the client App operates in the normal manner.

When the memory usage exceeds the maximum memory usage during the execution of the application in the online state, the native App 23 causes the application that is being executed to be forcibly terminated. The native App 23 performs forced uninstallation of the client App and deletes it from the user App list 43.

Even when the client App is reinstalled, the execution of the client App is suppressed until the memory usage becomes equal to or smaller than the maximum memory usage by uploading data to the server or deleting data by the control of the native App 23.

When the maximum memory usage is exceeded while the client App is stopped, the execution of the client App after that is suppressed by the control by the native App 23.

(Case No. 9)

The case in which the maximum memory usage “100” (unit: MB) of the client App is specified in the runnable condition (max-memory-size) of the client App for example, and “application-and-userdata” is specified in the forced uninstallation (force-uninstall), is explained.

When the current memory usage of the terminal 21 is equal to or smaller than the maximum usage of the client App in the offline state, the client App operates in the normal manner.

When the memory usage exceeds the maximum memory usage during the execution of the application in the online state, the native App 23 causes the application that is being executed to be forcibly terminated, and deletes the user data. The native App 23 deletes the client App from the user App list 43.

Even when the client App is reinstalled, the client App may be executed, since data are deleted and the memory usage has become equal to or smaller than the maximum memory usage.

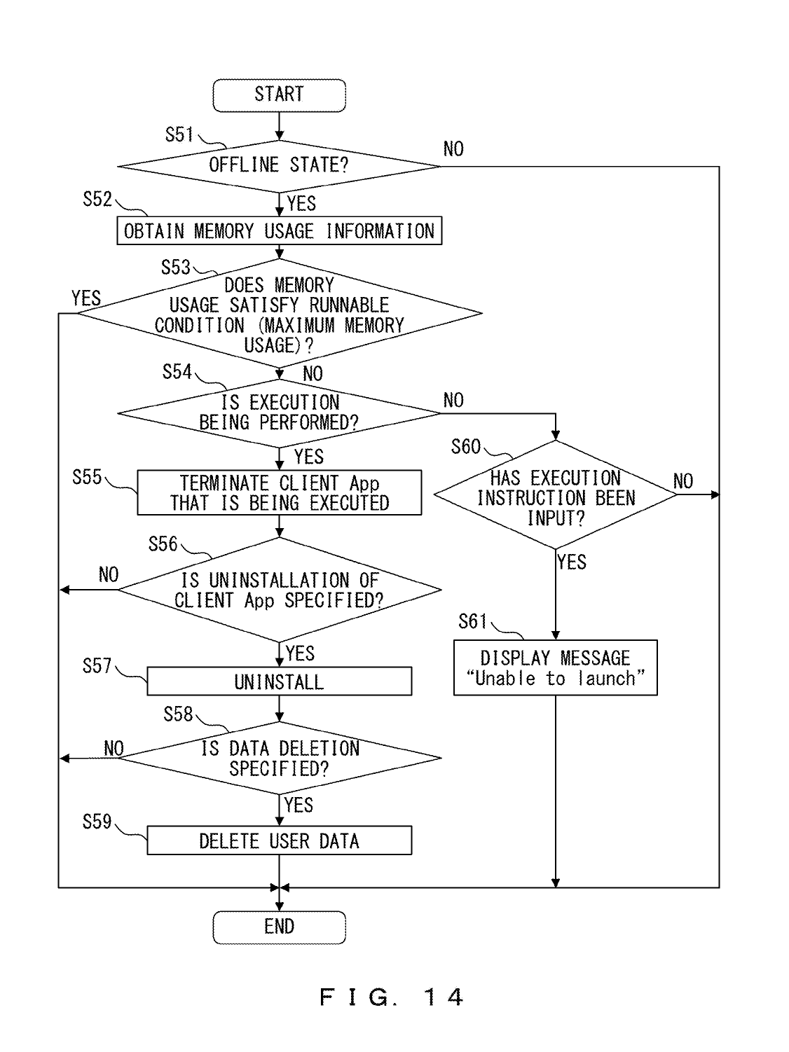

FIG. 14 illustrates the operation control flow for the client App in the offline state in the present embodiment (Example 3).

The communication state obtaining unit 32 obtains the communication state information of the terminal 21 from the communication state monitoring unit 31 on the OS 22 side. The communication state obtaining unit 32 judges whether the terminal 21 is in the state in which it is not connected to the network (offline state) (S51). When the terminal 21 is in the state in which it is connected to the network (when it is in the online state) (S51, “NO”), this flow is terminated.

When the terminal 21 is in the state in which it is not connected to the network (when it is in the offline state) (S51, “YES”), the memory usage obtaining unit 36 obtains the memory usage of the terminal 21 from the file system 40 (S52). The memory usage obtaining unit 36 transmits the obtained memory usage to the App execution control unit 33. The App execution control unit 33 obtains the memory usage from the memory usage obtaining unit 36.

The App execution control unit 33 judges whether the obtained operation definition information 41 corresponds to the runnable condition (the maximum memory usage) defined in the operation definition information 41 received from the App managing unit 34, as explained in FIGS. 13A and 13B (S53). When the memory usage corresponds to the runnable condition, that is, when the memory usage is within the maximum memory usage (S53, “YES”), this flow is terminated.

When the memory usage does not correspond to the runnable condition, that is, when the memory usage has exceeded the maximum memory usage (S53, “NO”), the App execution control unit 33 judges whether the client App (the target client App) that does not correspond to the runnable condition is being executed on the native App 23 (S54). When the target client App is being executed on the native App 23 (S54, “YES”), the App execution control unit 33 terminates the execution of the target client App (S55).

When the uninstallation of the target client App is not specified in the operation definition information 41 (S56, “NO”), this flow is terminated. When the uninstallation of the target client App is specified in the operation definition information 41 (S56, “YES”), the App execution control unit 33 instructs to the App managing unit 34 to uninstall the target client App. The App managing unit 34 performs uninstallation of the target client App according to the instruction (S57).

When there is no instruction to delete the user data of the target client App (the target user data) in the operation definition information 41 (S58, “NO”), this flow is terminated. When there is an instruction to delete the user data of the target client App (the target user data) in the operation definition information 41 (S58, “YES”), the App execution control unit 33 instructs to the SLS managing unit 35 to delete the target user data. The SLS managing unit 35 deletes the target user data according to the instruction (S59).

When the target client App is not being executed (S54, “NO”), the App execution control unit 33 judges whether an instruction to execute the target client App has been input (S60).

When no instruction to execute the target client App has been input (S60, “NO”), this flow is terminated. When an instruction to execute the target client App is input (S60, “YES”), the App execution control unit 33 causes a message “Unable to launch” to be displayed on the touch panel display 55 of the terminal 21 (S61).

According to Example 3, when the memory usage exceeds the maximum memory usage in the offline state, the operation of the client App may be suppressed by forcibly terminating the client App that is being executed or by not launching the client App for which an execution instruction has been issued.

According to the technologies described herein, data maintainability in an information processing terminal in the offline state or at the time of transition from offline to online may be improved.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recoding medium having stored therein a program that causes a processor of an information processing terminal communicates with a server apparatus to execute a process comprising:
obtaining, from an application program stored in the information processing terminal, operation condition information that defines an operation condition for the application program for a case in which the communication is restricted; and
suppressing an operation of the application program according to the operation condition information, in response to a detection of a state in which the communication is restricted.

2. The non-transitory computer-readable recoding medium according to claim 1, wherein
the operation condition information defines an operation condition for a case in which a communication function of the information processing terminal is restricted; and
an operation of the application program is suppressed according to the operation condition information, in response to the detection of a state in which a communication is restricted.

3. The non-transitory computer-readable recoding medium according to claim 1, wherein
the operation condition information defines an operation condition for a case in which communication of the information processing terminal with the server apparatus is restricted; and
an operation of the application program corresponding to the operation condition information is suppressed according to the operation condition information, in response to the detection of a state in which the communication with the server apparatus is restricted.

4. The non-transitory computer-readable recoding medium according to claim 1, wherein
in the process of suppressing,
in a case in which a time during which the communication is restricted exceeds a threshold set in the operation condition information, an operation of the application program corresponding to the operation condition information is suppressed.

5. The non-transitory computer-readable recoding medium according to claim 1, wherein
in the process of suppressing,
in a case in which the communication is restricted and an expiration deadline of an application program set in the operation condition information is exceeded, an operation of the application program corresponding to the operation condition information is suppressed.

6. The non-transitory computer-readable recoding medium according to claim 1, wherein
in the process of suppressing,
in a case in which the communication is restricted and a used quantity of a storing apparatus of the information processing terminal exceeds a threshold set in the information processing terminal, an operation of the application program corresponding to the operation condition information is suppressed.

7. The non-transitory computer-readable recoding medium according to claim 1, wherein
in the process of suppressing,
in a case in which the communication is restricted, an operation of the application program corresponding to the operation condition information is suppressed by forcibly terminating the application program that is being executed, or by causing a prescribed message to be displayed without launching the application program for which an execution instruction has been issued, according to the operation condition information.

8. An information processing terminal comprising:
a processor that
performs communication with a server apparatus;
stores an application program that is provided with operation condition information that defines an operation condition of an application program for a case in which the communication is restricted;
obtains the operation condition information from the application program; and
suppresses an operation of the application program according to the operation condition information, in response to a state in which the communication is restricted.

9. A control method executed by a processor of an information processing terminal that communicates with a server apparatus, the control method comprising:
obtaining, from an application program stored in the information processing terminal, operation condition information that defines an operation condition for the application program for a case in which the communication is restricted; and
suppressing an operation of the application program according to the operation condition information, in response to a detection of a state in which the communication is restricted.
